(19) United States
(12) Patent Application Publication
(10) Pub. No.: US 2011/0107239 A1
(43) Pub. Date: May 5, 2011

(54) DEVICE, SYSTEM AND METHOD OF INTERACTIVE GAME

(76) Inventors: Uri Adoni, Kfar Neter (IL); Irit Hillel, Tel Aviv (IL)

(21) Appl. No.: 12/736,668

(22) PCT Filed: Apr. 30, 2009
(86) PCT No.: PCT/IB2009/051768

§ 371 Date: Jan. 6, 2011

Related U.S. Application Data
(60) Provisional application No. 61/049,458, filed on May 1, 2008.

(51) Int. Cl. G06F 3/048; H04L 9/32; G06F 21/00

(52) U.S. Cl. 715/757; 726/8

(57) ABSTRACT

Device, system, and method of interactive game. For example, a system includes: a server to host a virtual hub associated with a plurality of spokes, wherein each spoke leads users to a plurality of virtual worlds having a common characteristic, wherein the virtual hub and the spokes comprise a virtual worlds network, wherein the server comprises a single sign-on module able to receive from a user a first set of sign-on data items, and able to sign-on the user to a first virtual world and to a second virtual world.

### FIELD

Some embodiments of the invention are related to the field of interactive games.

### BACKGROUND

Some electronic communication systems allow users to engage in online games. For example, a user may utilize a desktop computer to access a World Wide Web page which includes an online Flash or Java game; and the user may utilize the keyboard and/or the mouse to play the online game.

The World Wide Web includes numerous web-sites which offer to users various online games, for example, action games (e.g., “Space Invaders”), arcade games (e.g., “Pac-Man”), word games (e.g., “Scrabble”), virtual sports games (e.g., virtual tennis), card games (e.g., “Blackjack”), strategy games (e.g., chess), or the like.

Unfortunately, many online games are not suitable for children, and/or do not provide an educational added value to children who play such online games.

Some electronic communication systems allow users to interact within a Virtual World (VW). For example, a user may select an avatar, which may be a graphical representation of a virtual entity of the user. The user may command the avatar to move and act in the VW, and may optionally command the avatar to interact with avatars of other users.

### SUMMARY

Some embodiments include, for example, devices, systems, and methods of interactive game.

In some embodiments, for example, a system includes: a server to host a virtual hub associated with a plurality of spokes, wherein each spoke leads users to a plurality of virtual worlds having a common characteristic, wherein the virtual hub and the spokes comprise a virtual worlds network, wherein the server comprises a single sign-on module able to receive from a user a first set of sign-on data items, and able to sign-on the user to a first virtual world and to a second virtual world.

In some embodiments, for example, the server comprises an avatar modification module to transform a first avatar associated with the user in the first virtual world, into a second avatar associated with the user in the second virtual world.

In some embodiments, for example, the avatar modification module is to transform the first avatar into the second avatar based on a server-side lookup table storing indications of corresponding avatars across a plurality of virtual worlds.

In some embodiments, for example, the avatar modification module is to transform an accessory of the first avatar, associated with the first virtual world, into another accessory of the second avatar, associated with the second virtual world.

In some embodiments, for example, the server comprises a currency converter module to transform a first balance in a first virtual currency associated with the user in the first virtual world, into a second balance in a second virtual currency associated with the user in the second virtual world.

In some embodiments, for example, the server comprises an Instant Messaging (IM) communication module to receive an IM message from a first user in the first virtual world, and to present the IM message to a second user in the second virtual world.

In some embodiments, for example, the server comprises a social networking module to receive a social networking module to receive a social networking content item from a first user in the first virtual world, and to present the social networking content item to a second user in the second virtual world.

In some embodiments, for example, the server comprises a matching module to send to a user of the first virtual world a proposal to befriend a user of the second virtual world.

In some embodiments, for example, the single sign-on module is to generate, from the first set of sign-on data items: a first set of data items for signing-on the user to the first virtual world, and a second set of data items for signing-on the user to the second virtual world.

In some embodiments, for example, the server comprises a module for trading of virtual items among users of the virtual worlds network.

In some embodiments, for example, the server comprises a module for auctioning of virtual items among users of the virtual worlds network.

In some embodiments, for example, the server comprises a module for User Generated Content (UGC) activities.

In some embodiments, for example, a method of operating an interactive game includes: displaying a graphical representation of a geographical area, wherein the graphical representation comprises one or more user-selectable icons corresponding to one or more respective geographical locations in said geographical area; and in response to a user selection of one of the icons, activating an interactive game having content related at least partially to the geographical location corresponding to the selected icon.

In some embodiments, for example, activating comprises: activating an interactive game having content related to a work-of-authorship, wherein the work-of-authorship is related at least partially to the geographical location corresponding to the selected icon.

In some embodiments, for example, the work-of-authorship comprises a work-of-authorship selected from the group consisting of: a folk tale that takes place in the geographical location corresponding to the selected icon; a fairy tale that takes place in the geographical location corresponding to the selected icon; a fiction story that takes place in the geographical location corresponding to the selected icon; a non-fiction story that takes place in the geographical location corresponding to the selected icon; a television production that takes place in the geographical location corresponding to the selected icon; a movie production that takes place in the geographical location corresponding to the selected icon; an animated cartoon that takes place in the geographical location corresponding to the selected icon; and a story written by an author from the geographical location corresponding to the selected icon.

In some embodiments, for example, the method includes: playing a digital version of at least a portion of the work-of-authorship.

In some embodiments, for example, the method includes: pausing the playing of the digital version; activating an online game related to the work-of-authorship; and upon successful completion of the online game, resuming the playing of the digital version.

In some embodiments, for example, the method includes: generating an online chat session between a first user represented by a first character of said work-of-authorship and a second user represented by a second character of said work-of-authorship.

In some embodiments, for example, the method includes: receiving from the first user a selection of a chat phrase from a pre-defined list of chat phrases; and displaying the chat phrase to the second user.

In some embodiments, for example, the method includes: receiving from the first user a selection of a chat phrase in a first language; and displaying to the second user a translation of the chat phrase in a second language.

In some embodiments, for example, the method includes: generating an online chat session between a user represented by a first character of said work-of-authorship and a computer-controlled second character of said work-of-authorship.

In some embodiments, for example, the method includes: generating an online chat session between a first user represented by a character of said work-of-authorship and a second user represented by another character of another work-of-authorship.

In some embodiments, for example, the method includes: displaying a graphical representation of a virtual village corresponding to a site mentioned in the work-of-authorship.

In some embodiments, for example, the method includes: displaying in the virtual village a graphical representation of a character from said work-of-authorship; and animating the graphical representation of the character in response to a user input.

In some embodiments, for example, the geographical area comprises one or more of: a two-dimensional landscape, a three-dimensional landscape, planet Earth, a real-life planet, a solar system, a portion of a solar system, an imaginary planet, a fantasy world, a historical world, an ancient world, a mythological world, a fiction world, and a semi-realistic world.

In some embodiments, for example, at least part of the interactive game comprises User Generated Content (UGC).

Some embodiments may include, for example, a computer program product including a computer-useable medium including a computer-readable program, wherein the computer-readable program when executed on a computer causes the computer to perform methods in accordance with some embodiments.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIGS. 2A-2E are schematic illustrations of stages in a virtual game, in accordance with some demonstrative embodiments.

FIG. 3 is a schematic block diagram illustration of a Virtual Worlds Network (VWN) in accordance with some demonstrative embodiments.

### DETAILED DESCRIPTION

In the following detailed description, numerous specific details are set forth in order to provide a thorough understanding of some embodiments of the invention. However, it will be understood by persons of ordinary skill in the art that some embodiments may be practiced without these specific details. In other instances, well-known methods, procedures, components, units and/or circuits have not been described in detail so as not to obscure the discussion.

The terms “plurality” or “a plurality” as used herein include, for example, “multiple” or “two or more”. For example, “a plurality of items” includes two or more items.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device (e.g., a device incorporating functionalities of multiple types of devices, for example, PDA functionality and cellular phone functionality), a vehicular device, a non-vehicular device, a mobile or portable device, a non-mobile or non-portable device, a gaming console, a portable or non-portable gaming console, a mobile or non-mobile gaming console, a wireless communication station, a wireless communication device, a wireless Access Point (AP), a wireless Base Station (BS), a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a “smartphone” device, a wired or wireless handheld device (e.g., BlackBerry (RTM), Palm (RTM) Treo (TM)), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), IEEE 802.11 (“Wi-Fi”), IEEE 802.16 (“Wi-Max”), ZigBee (TM), Ultra-Wideband (UWB), Global System for Mobile communication (GSM), 2G, 2.5G, 3G, Third Generation Partnership Project (3GPP), 3GPP Long Term Evolution (LTE), 3.5G, future technologies and/or standards of cellular communication and/or wireless communication, or the like. Some embodiments may be used in conjunction with various other devices, systems and/or networks.

The terms “wireless device”, “wireless computing device”, “mobile device” or “mobile computing device” as used herein include, for example, a device capable of wireless communication, a communication device or communication station capable of wireless communication, a desktop computer capable of wireless communication, a mobile phone, a cellular phone, a laptop or notebook computer capable of wireless communication, a PDA capable of wireless communication, a handheld device capable of wireless communication, a portable or non-portable device capable of wireless communication, or the like.

The terms “social network”, “virtual social network”, or “VSN” as used herein include, for example, a virtual community; an online community; a community or assembly of online representations corresponding to users of computing devices; a community or assembly of virtual representations corresponding to users of computing devices; a community or assembly of virtual entities (e.g., avatars, usernames, nicknames, or the like) corresponding to users of computing devices; a web-site or a set of web-pages or web-based applications that correspond to a virtual community; a set or assembly of user pages, personal pages, and/or user profiles; web-sites or services similar to “Facebook”, “MySpace”, “LinkedIn”, Whirled, Webkinz, Gaia online, Club Penguin, or the like.

In some embodiments, a virtual social network includes at least two users; in other embodiments, a virtual social network includes at least three users. In some embodiments, a virtual social network includes at least one “one-to-many” communication channels or links. In some embodiments, a virtual social network includes at least one communication channel or link that is not a point-to-point communication channel or link. In some embodiments, a virtual social network includes at least one communication channel or link that is not a “one-to-one” communication channel or link.

The terms “social network services” or “virtual social network services” as used herein include, for example, one or more services which may be provided to members or users of a social network, e.g., through the Internet, through wired or wireless communication, through electronic devices, through wireless devices, through a web-site, through a stand-alone application, through a web browser application, or the like. In some embodiments, social network services may include, for example, online chat activities; textual chat; voice chat; video chat; Instant Messaging (IM); non-instant messaging (e.g., in which messages are accumulated into an “inbox” of a recipient user); sharing of photographs and videos; file sharing; writing into a “blog” or forum system; reading from a “blog” or forum system; discussion groups; electronic mail (email); folksonomy activities (e.g., tagging, collaborative tagging, social classification, social tagging, social indexing); forums; message boards, User-Generated Content (UGC) activities; or the like.

The terms “web” or “Web” as used herein includes, for example, the World Wide Web; a global communication system of interlinked and/or hypertext documents, files, web-sites and/or web-pages accessible through the Internet or through a global communication network; including text, images, videos, multimedia components, hyperlinks, or other content.

The terms “Virtual World” or “VW” as used herein include, for example, a computer-based simulated environment intended for its users to inhabit and interact via avatars. The avatars may be textual representations, two-dimensional or three-dimensional graphical representations (or without visual representation), or the like. The user's computer accesses a computer-simulated world, and presents perceptual stimuli to the user, who in turn can manipulate elements of the modeled world and thus experiences tele-presence to a certain degree. Such modeled worlds may appear similar to the real world or instead may depict fantasy worlds, alternative reality, Science Fiction (Sci-Fi) world, past world, historic worlds, mythological worlds, fan clubs, user-generated worlds and games, or the like. The model world may simulate rules based on the real world or some hybrid fantasy world. Example rules are gravity, topography, locomotion, real-time actions, and communication. Communication between users may include, for example, text, graphical icons, visual gesture, or the like. Some VWs are implements as massively multiplayer online games, which depict a world very similar to the real world, with real world rules and real-time actions, and communication. Other suitable implementations of VWs may be used.

Although portions of the discussion herein relate, for demonstrative purposes, to Flash content (e.g., virtual world, virtual locations, games, or virtual content), some embodiments may include other types of content, which may not necessarily be Flash based; for example, Java content, Active-X control content, Unity content, online content, offline content, downloadable content, installable content, content that require a plug-in or a browser extension, JavaScript content, HTML content, Dynamic HTML content, Shockwave content, Silverlight content, or other suitable types of content. In some embodiments, virtual worlds, virtual locations, and/or virtual games need not be Flash-based, and may be implemented using other suitable technologies.

In some embodiments, content may be static or non-moving; in other embodiments, content may be moving or animated, or may include characters or graphical representations which may be moving or animated. In some embodiments, one or more (or all) of the graphical representations or graphical components may be animated, for example, characters, virtual locations, virtual assets and accessories, scenery, or the like.

The term “user” as used herein includes, for example, a person or entity that owns a computing device or a wireless device; a person or entity that operates or utilizes a computing device or a wireless device; or a person or entity that is otherwise associated with a computing device or a wireless device.

The term “friend” as used herein includes, for example, another user; a family member; a relative; an acquaintance; a colleague; a co-worker; a person that the user knows from personal, professional or other backgrounds; a person that the user knows from real-world interaction or meeting; and/or a person that the user knows from virtual interaction and/or virtual meeting (e.g., email exchange, instant messaging, online chat, or the like).

The term “work of authorship” as used herein includes, for example, a story, a plot, a novel, a tale, a book, a folk tale, a fairy tale, a legend, a historic tale, a fiction story, a non-fiction story, a television production, a movie or film production, an animated cartoon, a comics strip, a comics book, or the like.

In some embodiments, a work-of-authorship is “related” to a geographical location, for example, if at least a portion of the content of the work-of-authorship took place or takes place in the geographical location (e.g., the story of Robin Hood, which takes place at least in part in Sherwood Forest in England, is thus “related” to Sherwood Forest and to England); or if the geographical location is mentioned in, or appears in, the content of the work-of-authorship (e.g., the television production “Full House”, which shows San Francisco, is “related” to San Francisco); or if an author of the work-of-authorship lives or lived, at least partially, in the geographical location (e.g., the fairy tale “Rapunzel” is “related” to Germany since the tale's authors, the Brothers Grimm, lived in Germany); or if the work-of-authorship is commonly or typically associated with the geographical location (e.g., the story of William Tell is commonly associated with Swizerland); or if at least one character from the work-of-authorship is commonly or typically associated with the work-of-authorship. In some embodiments, the geographical location may be related to a planet different than Earth, for example, another planet, Superman's Krypton, or the like.

At an overview, some embodiments include a virtual game which displays a two-dimensional or three-dimensional graphical map of a geographical area. The displayed map includes user-selectable icons or areas; selection of an icon by a user invokes or activates an interactive game having content or a character related, at least partially, to a work-of-authorship associated with the geographical location that corresponds to the selected icon. For example, a user selection of the “Sherwood Forest” icon in the map invokes, directly or directly (e.g., through one or more passages) an interactive game which takes place in a virtual Sherwood Forest, or which involves a “Robin Hood” character.

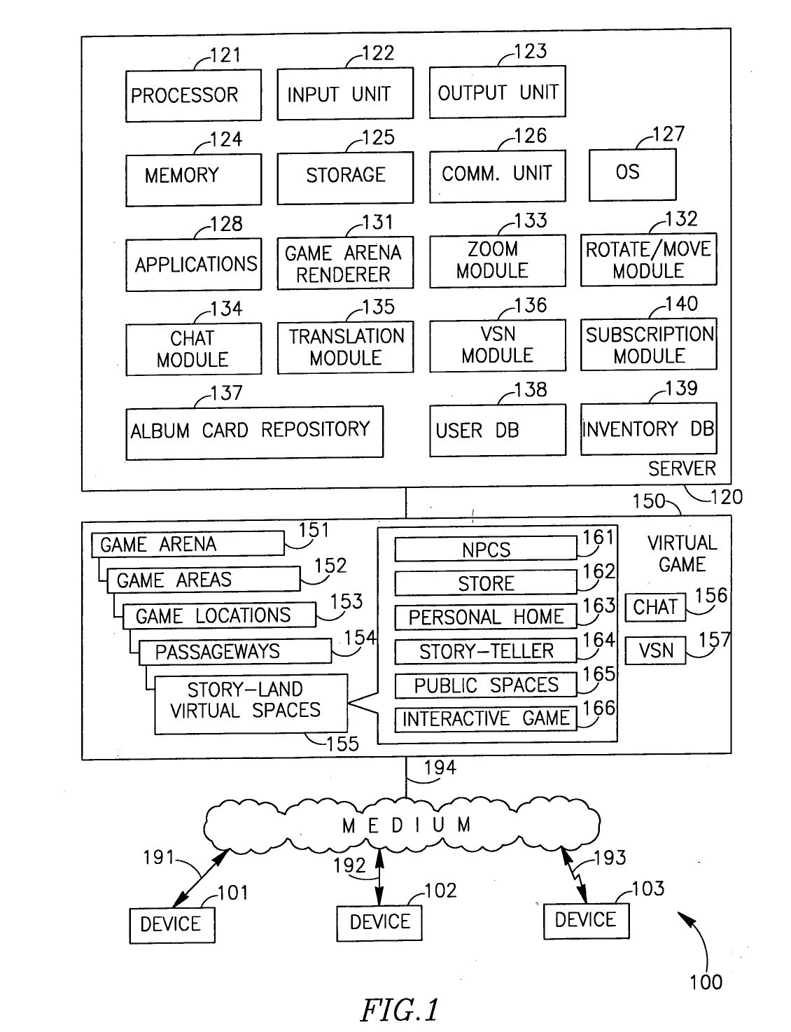

FIG. 1 schematically illustrates a block diagram of a system 100 in accordance with some demonstrative embodiments of the invention. System 100 includes a server 120 and one or more computing devices, for example, devices 101-103. Each one of devices 101-103 may include a wired computing device or a wireless computing device, for example, a desktop computer, a laptop computer, a PDA device, a cellular phone, an interactive television, a gaming console, or the like.

Each one of devices 101-103 is able to access a communication network 190 through wired and/or wireless links 191-193, respectively. Communication network 190 may be or may include, for example, a global communication network, the Internet, the World Wide Web, a wired network, a wireless network, a combination of one or more wired networks and/or one or more wireless networks, a shared access medium, or the like. In some embodiments, communication network 190 may include one or more wired and/or wireless communication networks, for example, an a-synchronic or asynchronous wireless network, a synchronic wireless network, a managed wireless network, a non-managed wireless network, a burstable wireless network, a non-burstable wireless network, a scheduled wireless network, a non-scheduled wireless network, or the like.

Server 120 is able to access the communication network 190 through a wired and/or wireless link 194. In some embodiments, server 120 may be implemented using suitable hardware components and/or software components, for example, a processor 121, an input unit 122, an output unit 123, a memory unit 124, a storage unit 125, and a communication unit 126. Similar components may be included in each one of devices 101-103.

Processor 121 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or other suitable multi-purpose or specific processor or controller. Processor 121 executes instructions, for example, of an Operating System (OS) 127 or of one or more applications 128.

Input unit 122 includes, for example, a keyboard, a keypad, a mouse, a touch-pad, a touch-screen, a joystick, a track-ball, a stylus, a microphone, or other suitable pointing unit or input device. Output unit 123 includes, for example, a monitor, a screen, a touch-screen, a Cathode Ray Tube (CRT) display unit, a Liquid Crystal Display (LCD) display unit, a plasma display unit, one or more audio speakers or earphones, or other suitable output devices.

Memory unit 124 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 125 includes, for example, a hard disk drive, a floppy disk drive, a Compact Disk (CD) drive, a CD-ROM drive, a Digital Versatile Disk (DVD) drive, an internal or external database or repository, or other suitable removable or non-removable storage units. Memory unit 124 and/or storage unit 125, for example, store data processed by server 120.

Communication unit 126 includes, for example, a wired or wireless transceiver, a wired or wireless modem, a wired or wireless Network Interface Card (NIC), or other unit suitable for transmitting and/or receiving communication signals, blocks, frames, transmission streams, packets, messages and/or data. Optionally, communication unit 126 includes, or is associated with, one or more antennas or one or more sets of antennas.

In some embodiments, some or all of the components of server 120 are enclosed in a common housing or packaging, and are interconnected or operably associated using one or more wired or wireless links. In other embodiments, components of server 120 are distributed among multiple or separate devices or locations.

Some embodiments may utilize client/server architecture, publisher/subscriber architecture, fully centralized architecture, partially centralized architecture, fully distributed architecture, partially distributed architecture, scalable Peer to Peer (P2P) architecture, or other suitable architectures or combinations thereof. In some embodiments, one or more functions described herein with reference to server 120 may be performed by one or more of devices 101-103.

Server 120 is able to generate, host and/or operate a virtual game 150, for example, targeted to and/or suitable particularly for children (e.g., at ages 6 to 11). The virtual game 150 takes place in a game arena 151, for example, a graphical representation that includes planet Earth and optionally one or more surrounding planets, or the universe. The game arena 151 (e.g., planet Earth) may be divided (e.g., initially or upon selection and zoom-in) into user-selectable game areas 152, for example, continents, geographical regions (e.g., the Middle East, the Far East), countries, and/or other geographical objects (e.g., oceans or seas). Each game area 152 may be divided (e.g., initially or upon selection and zoom-in) into one or more user-selectable game locations 153, for example, cities, forests, deserts, lakes, or the like. Each game location 153 may include (e.g., initially or upon selection and zoom-in) one or more passages 154 to story-land virtual spaces 155 (“villages”) that correspond to the respective game location 153.

For example, in some embodiments, the game arena 151 is a graphical representation, two-dimensional map, or three-dimensional map of planet Earth. Other suitable types of areas or landscapes may be used, for example, semi-realistic planet Earth, imaginary planet, multiple planets, or the like. The game arena 151 is divided into user-selectable game areas 152, such that each game area corresponds to a user-selectable continent. The user may select a graphical representation of a continent (e.g., Europe), and automatically the virtual game 150 may zoom-in on the selected game area 152, which may be presented in an enlarged graphical representation, e.g., substantially replacing the graphical representation of the planet Earth. In some embodiments, the user-selected game area 152 (e.g., Europe) may be shown divided into multiple user-selectable sub-areas (e.g., countries), which in turn may include multiple game locations 153; in some embodiments, the user-selected game areas 152 (e.g., Europe) may be shown to include the multiple game locations 153. For example, the user-selected game area 152 may be shown as a graphical representation of Europe, showing a user-selectable graphical and/or textual representation of particular game locations 153, e.g., Sherwood forest in England, La Mancha in Spain, the Canton or Uri in Switzerland, or the like. Once the user selects a particular game location 153, the virtual game 150 shows a respective graphical passageway 154 into an interactive story-land virtual space 155 related to the user-selected game location 153. For example, user selection of the game location 153 of Sherwood forest in England may trigger a passageway 154 to an interactive story-land virtual space 155 related to the story of Robin Hood; user selection of the game location 153 of La Mancha in Spain may trigger a passageway 154 to an interactive story-land virtual space 155 related to the story of Don Quixote; user selection of the game location 153 of the Canton or Uri in Switzerland may trigger a passageway 154 to an interactive story-land virtual space 155 related to the story of William Tell; or the like.

Each game location 154 may be, for example, a real geographical location (e.g., Sherwood forest in England); a semi-real location, for example, an imaginary or non-real location within a real country (e.g., the forest of Hansel and Gretel in Germany); or an imaginary or non-real location (e.g., the kingdom of Atlantis, the Middle Earth of “The Hobbit”), or a different planet.

Graphical representations or component of the virtual game 150 may be generated by server 120, for example, using a game arena renderer 131. Optionally, a rotate/move module 132 allows a user to rotate or otherwise move the graphical representation of the virtual game (e.g., rotate a globe, or move on a map); and a zoom module 133 allows a user to zoom-in or zoom-out relative to a user-selected game location 153 or game areas 152. In some embodiments, the game arena 151 or portions thereof may be implemented, for example, similarly to Google Earth or other virtual globe applications which allow the user to zoom-in, zoom-out, rotate, move, “fly” between points, or the like.

Although portions of the discussion herein relate, for demonstrative purposes, to division of the game arena 151 into multiple game areas 152 that are divided into multiple game locations 154 (which in turn include one or more passageways 154 to one or more story-land virtual spaces 155), some embodiments may utilize other types of geographical resolution or other levels of granularity. Some embodiments may utilize, for example, division to continents, geographical regions, countries, cities, geographical regions, areas, sub-areas, locations (e.g., a city), sub-locations (e.g., a market within the city, a city hall), points of interest, or the like. In some embodiments, imaginary or semi-imaginary game locations 153 may be placed according to a location scheme defined by the administrator of the virtual game 150; for example, the kingdom of Atlantis may be located in an ocean.

Each story-land virtual space 155 is associated with a game location 153. In some embodiments, a story-land virtual space 155 may be associated with a children story, a children tale or a children book associated with that game location 153, or which takes place at that game location; for example, a story-land virtual space 155 about “Hansel and Gretel” may be accessed through a game location 153 of Germany (in which the children story of “Hansel and Gretel” takes place). In some embodiments, a story-land virtual space 155 may be associated with a plot of an animated movie; for example, a story-land virtual space 155 about the movie “Finding Nemo” may be accessed through a game location 153 of Sydney, Australia (in which a portion of the movie “Finding Nemo” takes place). In some embodiments, a story-land virtual space 155 may be associated with a television series; for example, a story-land virtual space 155 about the situation comedy “Full House” may be associated with a game location 153 of San Francisco (in which this situation comedy takes place). In some embodiments, a story-land virtual space 155 may be associated with a cartoon; for example, a story-land virtual space 155 about the “Road Runner” cartoon may be associated with a game location 153 of the Southwestern United States (in which this cartoon takes place). In some embodiments, a story-land virtual space 155 may be associated with a comics books or other comics creation; for example, a story-land virtual space 155 about the comics book “The Adventures of Asterix” may be associated with a game location 153 of France or ancient Gaul (in which this comics book takes place). In some embodiments, a story-land virtual space 155 may be associated with a folk tale or fairy tale or legend; for example, a story-land virtual space 155 about the legend of “William Tell” may be associated with a game location 153 of Canton or Uri in Switzerland (in which this folk tale or legend takes place). In some embodiments, locations on the globe may be categorized based on their landscape type, for example, desert, jungle, city, ocean, core of the Earth, clouds, outer space, or the like.

In some embodiments, when first visiting a user-selectable game location 153, optionally, the virtual game 150 displays one or more images (e.g., photographs or realistic pictures) of the real-world location that corresponds to that game location 153. For example, upon selection of the game location “La Mancha” in Spain, the virtual game 150 may present (e.g., for a short period of time, or using fade-in and fade-out animation, or the like) a photograph or image of the windmills of La Mancha in Spain.

In some embodiments, the passageways 154 and/or the story-land virtual spaces 155 may be fully visible and/or fully accessible to users. In other embodiments, one or more passageways 154 and/or story-land virtual spaces 155 may be hidden or non-accessible, and may be “unlocked” and become accessible (e.g., through an appearing “entrance” graphical representations) after the user of the virtual game 150 successfully performs a pre-defined task, for example, finds a secret or hidden passage, solves a riddle, finds a key, or the like. In some embodiments, premium content or subscription-based content may be unlocked and/or may become available or accessible to a non-premium user, for example, by paying in order to gain access, by completing particular tasks in order to gain access, by achieving particular scores or results, by winning particular challenges, or based on a combination of multiple conditions. In some embodiments, a particular game location 153 may be associated with two or more passageways 154 or two or more story-land virtual spaces 155.

In some embodiments, the virtual game 150 may be multi-lingual. For example, a user may select a language upon logging-in to the virtual game 150, and game content (e.g., text, graphics, and optionally audio and/or video) may be presented to the user in the selected language; for example, server 120 may store multiple versions of texts, graphics, audio object and/or video objects (or other multimedia objects) corresponding to multiple supported languages.

In some embodiments, the virtual game 150 may include automatic real-time translation. For example, a portion of the virtual game 150 may include a chat component 156, e.g., a chat-room for multiple users, an ad-hoc chat between two users, a private chat between two users, a public chat among three or more users or a between a user and a group of users, or the like. The server 120 may include a chat module 134 to provide the chat service, and may further include a translation module 135 allowing one-way or two-way translation of chat content substantially in real time. For example, a first user may select to communicate in French, and a second user may select to communicate in Spanish; the first and second user may engage in chat in the virtual game 150; the first user may enter text in French, and the entered text may be automatically translated from French to Spanish and be displayed in Spanish to the second user; the second user may enter text in Spanish, and the entered text may be automatically translated from Spanish to French and displayed in French to the first user. In some embodiments, the chat module 134 may allow users to communicate utilizing free-text entered by the users (optionally subject to parental approval), and/or using pre-defined sentences to allow “quick chat” and/or “safe chat” among users.

In some embodiments, content of the virtual game 150 may be dynamically modified, added and/or removed, for example, while users are playing the virtual game 150. For example, a new game location 153 may be added, or a new story-land virtual space 155 may be added. In some embodiments, a game location 153 and/or a story-land virtual space 155 may be customized based on a request of a content partner (e.g., a copyright holder of the story related to the game location 153 or the story-land virtual space 155). In some embodiments, the virtual game 150 or components thereof may be branded, may be re-branded, may be implemented as a “white label” or “private label” game or components, or the like.

Each story-land virtual space 155 may be a mini virtual world revolving around a selected plot, theme, character, or story. A story-land virtual space 155 may include story-related locations, displaying selected scenes from the relevant story. A story-land virtual space 155 may optionally include one or more “bots” or Non-Playing Characters (NPCs) 161 corresponding to one or more characters of the relevant story, optionally utilizing branded characters, licensed characters, and/or originally-created characters. In some embodiments, NPCs (or Bots) may be added to users' friends list, and users may “befriend” them and communicate with them using all the social networking features available for real human Friends. In some embodiments, NPCs may have a certain Artificial Intelligence (AI) that allows them to react and respond to the users' communication.

A story-land virtual space 155 may further include a virtual store 162 selling story-related merchandise. In some embodiments, virtual stores 162 may sell to users accessories for their avatars, furniture or items for their virtual homes, “powers”, hints or clues to interactive games 166, gestures for their avatars, or the like. Optionally, one or more “global” virtual stores may be associated with the entire virtual game 150 (and not only with a particular story-land virtual space 155).

A story-land virtual space 155 may include a story-related personal home 163 (or other personal location) that a user may personalize, for example, using skins, by acquiring virtual goods, or the like. A story-land virtual space 155 may additionally include a story-telling area 164 in which the relevant story is conveyed to the user, for example, utilizing text, graphics, audio, video, multimedia objects, User Generated Content (UGC), or a combination thereof. In some embodiments, each story-land virtual space 155 may include one or more mechanisms to allow the user to learn about the relevant story, for example, a story synopsis, an interactive trivia game, a story teller, UGC activities, or the like. In some embodiments, an interactive game or an online game may include or may utilize traditional online games, UGC activities, pre-programmed content, UGC, pre-programmed gaming components, gaming components that result from UGC activities, or any suitable combination thereof.

Each story-land virtual space 155 may include one or more interactive games 166, for example, mini-games suitable for boys and/or girls. Each interactive game 166 may be related to the story of the story-land virtual space 155. In some embodiments, the interactive games 166 are presented or played in accordance with a “quest mode”, for example, a pre-defined order which unfolds the story of the story-land virtual space 155. In some embodiments, interactive games 166 are accessible from the relevant game location 153 in which they occur or to which they occur, and/or are played in the game location itself. In some embodiments, interactive games 166 may include single-user games and/or multi-user games. In some embodiments, interactive games 166 may allow the users (e.g., upon successful completion) to gain virtual money, virtual exchangeable items, or virtual “powers” or attributes.

In some embodiments, the story-land virtual space 155 may allow one-to-one communication in which a user is able to interact with a single story character; a many-to-one communication in which multiple users are able to interact with a single story character; or other suitable communication methods, e.g., many-to-many or one-to-many.

In some embodiments, the story-land virtual space 155 may be implemented using multiple public spaces 165. For example, a story that takes place in a particular city may include a market place, a city hall, a clock tower, or the like; and users that are “present” together in a virtual public space 165 may interact among themselves.

In some embodiments, multiple story-land virtual spaces 155 may share a single, common economy and a single, common currency (e.g., a single type of virtual money). In some embodiments, a character from a particular story-land virtual space 155 (e.g., the character of Robin Hood) may be able to visit one or more other, external, story-land virtual spaces 155 (e.g., the La Mancha story-land virtual space 155). Optionally, characters from different story-land virtual spaces 155 may be able to meet or interact among themselves in special virtual spaces or in certain virtual events.

In some embodiments, the entire virtual game 150, or a set of game areas 152 game locations 153 thereof, may be wrapped or associated with a cover-story providing a reason for exploration, for example, one or more exploration tasks or missions. For example, a user may be presented with a challenge to find a particular item, which is “hidden” or “waiting” in a random or-predefined game location 153 unknown to the user; the user may be required to explore multiple game locations 153 and/or multiple story-land virtual spaces 155 until he finds the required item or completes the target task.

In some embodiments, server 120 may include a virtual social network management module 136 able to generate, operate and manage one or more virtual social networks 157 associated with the virtual game 150. The virtual social networks may provide one or more virtual community services, for example, photo albums, “blog” services, or the like. In some embodiments, users of the virtual game 150 may meet and/or socialize in virtual spaces (e.g., avatar to avatar) and/or through online chat (e.g., user to user). In some embodiments, user-to-user chat may be performed as long as the users are logged in to the virtual game 150; whereas avatar-to-avatar chat may be performed only when the relevant avatars are present in same virtual space (e.g., the same story-land virtual space 155 or the same game location 153). In some embodiments, multiple users may form a group, may invite other users to join the group, and may share assets as a group.

In some embodiments, each user may be able to manage his friends list. For example, a friend may be able to view the user's personal profile, to view the friends list of the user, to visit virtual places or virtual houses of the user, or to give a virtual gift to the user. A user may search for additional friends and may add them to his friends list.

In some embodiments, each user of the virtual game 150 may be associated with a card album, which may be filled with virtual game cards earned while playing interactive games 166. Users may be able to collect and swap story-related game cards, or to buy and sell game cards (e.g., within the system 100, and/or using external auction web-sites). In some embodiments, server 120 may include an album card repository 137 to store data representing the album cards of users, as well as virtual game cards that are included in each album card.

In some embodiments, a story-land virtual space 155 or an interactive game 166 may allow a user to earn, purchase, or otherwise obtain a virtual item or object (e.g., a sword, a hat, a necklace, or the like). Server 120 may store a user database 138 associated with an inventory database 139 reflecting virtual items held by each user of the virtual game. In some embodiments, users may be able to swap or exchange inventory items, sell inventory items (e.g., in exchange for virtual currency), and/or buy inventory items (e.g., using virtual currency).

In some embodiments the story may be told or presented in a branching way, for example, by asking the user a question or by giving the user an option to select from multiple options, and then continuing the story, according to the user's input, to the next level, chapter, episode, question or task.

In some embodiments, the user database 138 may be used to track and log operations performed by a user; and the inventory database 139 may be used to track and log virtual items held by the user. Such information or selected portions thereof may be published in the user profile or may be made accessible to friends of the user. Other information may be tracked, published or made accessible to other users, for example, information indicating virtual spaces that the user visited, information indicating virtual items that the user purchased or sold, virtual events that the user attended or plans to attend, virtual awards that the user earned, friends that the user added to his friends list, or the like.

In some embodiments, a user may be represented in the virtual game 150 by an avatar. The avatar may be human-based (e.g., a user-selectable graphical image of a boy or girl) or brand-based (e.g., a cartoon). Avatars may be user-personalized and customizable, and may be controlled using the mouse, the keyboard, the numeric pad, or the like. In some embodiments, pressing a key in the numeric pad triggers the avatar to perform a certain gesture or dance or operation (e.g., a pre-defined dance, a random dance, laugh, fight) in various spaces of the virtual game 150, for example, in the story-land virtual space 155. In some embodiments, each key in the numeric keypad may trigger a different gesture or dancing move of the avatar, thereby allowing the user to initiate and control an animated dance of its avatar by pressing keys in the numeric keypad. In some embodiments, an avatar may “own” or may be associated with one or more “personal houses” or personal pages of the user that controls the avatar. Additionally or alternatively, in some embodiments, a user may be represented in a non-avatar way, for example, using an icon, a photo, a photo-icon similar to FaceBook's representation, a name or a nickname (e.g., similar to a Skype nickname), a cartoon character (which may be animated or not animated), a 2D or 3D object, or other suitable ways.

In some embodiments, optionally, the UI of the virtual game 150, or the UI of portions of the virtual game 150, may be automatically modified to accommodate one or more properties of an avatar or of multiple avatars, or to otherwise accommodate a user customization of an avatar or multiple avatars.

In some embodiments, avatar attributes (e.g., hair, clothes, colors, or the like) may be customized by the user. The user may purchase virtual items (e.g., clothes, hats) to enrich the avatar's wardrobe. In some embodiments, an avatar may have a pre-defined set of gestures (common gestures and/or tale-related gestures); additional gestures may be purchased in the virtual store, or may be granted to high-ranked users based on success in virtual games. In some embodiments, a user may enhance the avatar powers by purchasing story-related “powers” (e.g., Superman's robe, Spider-Man's suit). In some embodiments, avatar accessories are accessible at all times and may be taken to other tales. In some embodiments, avatar movement is controlled by mouse (e.g., clicking on a certain point moves the avatar to this direction) and/or keyboard (e.g., using the arrows and the space bar), or using other suitable input units, for example, a motion-based input unit, an accelerometer-based input unit, an input unit or control unit similar to units of the Nintendo Wii gaming console, a pen, a web-camera, voice control, voice commands, motion sensors, electronic sensors, or other suitable means. In some embodiments, each avatar has its own home, which may be customizable with pre-defined accessories; additional accessories may be bought in the virtual store or traded in the market place. In some embodiments, avatars can chat with each other or with the NPCs 161. In some embodiments, each avatar has a unique name entered or selected by the user; if a user-entered name is occupied, server 120 may suggest several other options similar to the name entered by the user.

In some embodiments, a user may obtain, purchase or otherwise own particular gestures, features or “powers” that will be available to his avatar. In some embodiments, acquired powers may be based on powers associated with branded characters (for example, a “superman” may be able to fly, whereas a “snow white” may not be able to fly), may be based on inventory items (for example, holding a magic wand may allow performance of magic tricks), or may be based on the particular story (e.g., a “prince” character may be able to perform a “kiss” gesture towards a “sleeping beauty” character). In some embodiments, power may be transferred by the user between virtual spaces, or may follow an avatar to other virtual spaces.

In some embodiments, server 120 includes a subscription module 140 allowing users to subscribe to premium services by paying a one-time subscription fee or a periodical fee. For example, some functions, services or portions of the virtual game 150 may be accessible by substantially all users; whereas some functions (e.g., trading virtual goods), services or portions (e.g., certain locations) may be accessible only to “premium users” who subscribed for the premium services. In some embodiments, premium users may be able to purchase particular premium items of clothing, accessories and/or furniture; open their virtual homes to visits by other users; participate in special activities hosted by the administrator of virtual game 150; and may access premium locations. In some embodiments, advanced avatar accessories are available only for premium members. In some embodiments, if a subscribed membership lapses or is canceled, the user may lose the virtual items and privileges that the membership allowed.

In some embodiments, the virtual game 150 thus includes a collection of virtual worlds (which may be, for example, Web-based, browser-based, Flash-based, Java-based, or the like), intended for children aged 6-11, taking place on planet Earth. Each world story is based on a well-known fairy tale, folk tales, cartoon, or the like. Some embodiments may teach user that “Every place has a story”, and that almost every place on planet Earth has at least one story associated with it. Some embodiments thus create a collection of virtual worlds, based on real-world geography; each world's plot is represented by a story; users are able to virtually live the story, learn it, take active part in the world's theme and events, share their experience and creations with other users, enhance their social abilities, share videos and multimedia files, meet and interact with the tale characters, participate in tale related activities, purchase tale related merchandize (e.g., shirts, books, DVDs), and otherwise interact. Some embodiments may allow children from all over the world to engage in a common virtual game 150.

In some embodiments, a background story or a cover story may be used to induce children to engage with the virtual game 150. For example, the background story may convey that a path connecting between the real world and the imaginary world has been opened, and that children are invited to take this path and explore the world of imagination.

In some embodiments, the virtual game 150 may be tailored to achieve one or more objectives, for example: to tell a story to users; to allow users to live the story and take active part in the plot; to create a social living world were children may live their virtual lives in the tale land, easily interact with each other, share their experience and ideas, and have fun; and/or to educate the user about world geography, cultures, peoples, and human kind. Some embodiments may be tailored to induce the user to explore the imaginary worlds, to reveal secret areas, and to become popular and/or powerful in the virtual game 150. Some embodiments may thus be implemented as a massive multi-player online game, which combines action, mystery, education, and/or a social network.

In some embodiments, a user starts the game by looking at a three-dimensional representation of the world globe. Vortex icons appear on every country in which a plot takes place. Optionally, ships, airplanes, flying balloons, birds, and/or other objects are shown moving around the globe. Each one of the displayed items may be clickable, and represents a Web-based or browser-based game or a passage or zoom-in to a subsequent level of the virtual game 150. For example, clicking on a vortex icon zooms-in one level, and the country map is displayed; vortex icons appear again, displayed on locations 153 of story-land virtual spaces 155. In some embodiments, a click on a vortex icon zooms-in to a realistic painting of the story area. The user is then presented with a basic quest or riddle, and is required to complete this relatively-easy task before he is able to enter story-land virtual space 155.

Once the user completes the basic quest, a key or door to the story-land virtual space 155 is revealed and the user enters the village of the story-land virtual space 155. The village may include multiple virtual places, for example, a users club; a market place; a movie room; a library; a virtual store; a story teller; one or more story-specific locations where activities related to the plot take place; UGC area; users living area; and an entrance to the plot, from which the main quest begins. In some embodiments, all or most of the virtual locations are accessible to all users. The user can explore the village, go inside each location and participate in the activities inside, go outside and explore the story related to the location, and play an active role in the story by taking the plot entrance (main quest).

In some embodiments, main characters (e.g., “bots” or NPCs 161) stand in certain places in the virtual village and surroundings, and answer the user's questions (e.g., using pre-defined chat). In some embodiments, each NPC 161 may represent an interactive game 166 related to the story. In some embodiments, winning a game grants the user with an accessory (or a portion thereof) related to the story. The user may be required to collect all the parts of an accessory and to assemble them in order to get the accessory. In some embodiments, each game session may reward the user with a different part selected randomly by the virtual game 150; the number of parts and accessories may be pre-defined.

The user may select to take the entrance to the main plot, and may thus take active part in the story. The theme may be unwrapped along the story, and may depend on the user's success. Inside the virtual story, the user may virtually walk or travel along a pre-defined trail where he meets the tale characters. The trail may have several stops or stages. In each stop, one of the characters appears or stands, tells part of the story, and optionally presents a task. The task may be a Web-based or browser-based mini-game related to the story, which the player needs to complete before he can proceed to the next stage. The main trail may include one or more side quests. Once the user reaches the end, he is rewarded with virtual money or other virtual awards. In some embodiments, at any given stage, the user is able to save his session and/or go back to the village center.

In some embodiments, the virtual game 150 may be rich with colors and sounds. For example, animated images may move around the globe and/or village to create a dynamic environment; smoke may come out from village chimneys; ships may sail in the sea; birds may be shown flying around; or the like. In some embodiments, tale main characters may walk along the main trail and make gestures to the user.

In some embodiments, each movement or operation in the virtual game 150 may have its unique sound. Additionally, a story teller voice may be of a famous actor who is well known to the children in their native language. In some embodiments, the tale plot is followed by tale-related or folk-related soundtrack or background music. For example, in some embodiments, fairy tales tunes may be used and played using classic instruments (harp, violin, or the like) or using modern instruments (guitar, drums, or the like).

In some embodiments, the virtual game 150 is operated by a user utilizing a User Interface (UI) including multiple components or buttons. For example, a magnifying-glass button may represent a zoom-in function; a home button may represent a command to go back to the opening page; a map icon or button triggers a map; a help button or icon directs the user to help screens; or the like. Other suitable buttons or icons may be used to indicate, for example, avatar selection and customization; entrance to a selected area; selection and/or performance of gestures; engaging in chat, free-text chat, or pre-defined messages text; viewing or editing a friends list; or the like. Additionally, the UI may include non-clickable information or other items, for example, an indication of the user's balance of virtual money, a messaging field, or the like.

Some embodiments may include tools for moderation and parental supervision. In some embodiments, a user's parent may be able to limit the child user's permissions, for example, to disallow a child to participate in chat at all, to disallow a child to participate in free-text chat, to allow chat using pre-defined sentences, or the like. In some embodiments, the user database 138 may be used to track and logs operations performed by users, and server 120 may generate periodic reports about a user's progress or actions; the reports may be sent automatically to a user's parent. In some embodiments, one or more users may act as moderators, may supervise activities of other users, may review all suggestions sent by other users, and may be able to expel or penalize users who violate game moderation rules.

In some embodiments, chat performed using predefined templates may be “safe” and need not be moderated. In some embodiments, free-text chat is moderated online; in substantially real time; a violation of chat restrictions may cost the offender a “warning”; three warnings may automatically ban the user from the virtual game 150 for a predefined time period (e.g., several days), or may ban the user from chatting only for a predefine time period (e.g., one week).

In some embodiments, forums may be moderated offline. In some embodiments, moderated messages are removed, or their content is modified to “Message deleted by moderator”. A violation of forum restrictions may cost the offender a “warning”; three warnings may automatically ban the user from the virtual game 150 for a predefined time period (e.g., several days), or may ban the user from accessing the forum for a predefine time period (e.g., one week).

In some embodiments, each user may have a single virtual home in the virtual game 150. The user may access his virtual home, at any time, from any story-land space, for example, by following the “living area” path or by selecting a pre-defined button. The home interior walls (e.g., “skin”) may be decorated according to the story-land in which user currently resides. The user may buy, sell or trade accessories to decorate his virtual home; the accessories may be obtained or viewed from the story-land in which the virtual home resides, and/or from other story-lands. In some embodiments, other users may be able to visit the virtual home of the user, for example, freely or subject to the user's invitation or approval.

In some embodiments, each user has a personal profile, which may be edited or modified by the user at any time. The user profile may include, for example, user details, image, avatar, virtual home, tales that he visited, hero state or success rank, accessories, groups that he is part of, friends list, or the like. In some embodiments, a personalized globe representation may be shown, indicating locations that the user already visited. The user's virtual home may be accessible from the user's profile. Optionally, the user may have a personal album that he may fill with cards or pictures that he collected in the virtual game.

In some embodiments, each user may manage his friends list. Friends may have special privileges, for example, to view the user's personal items, to visit the user's virtual home (if it is restricted to friends only), or the like. In some embodiments, friends may share accessories and information with each other. In some embodiments, a user may search his friends and see their profiles; adding a user to the friends list requires the approval of that user.

In some embodiments, users may form groups and invite other users to join. A group may be public or restricted (e.g., such that joining the group requires the approval of the user, a set of users, or a parent of a user. In some embodiments, groups may share virtual assets. In some embodiments, each story-land may be associated with a forum allowing users to express themselves. The sharing may be done in a synchronized way, or in a non-synchronized way.

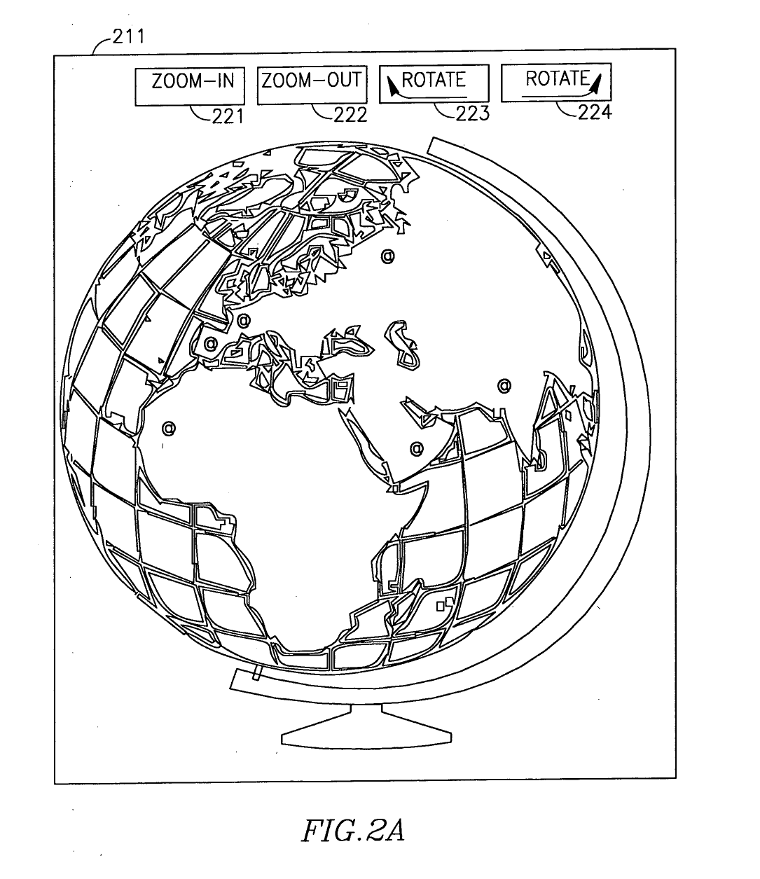

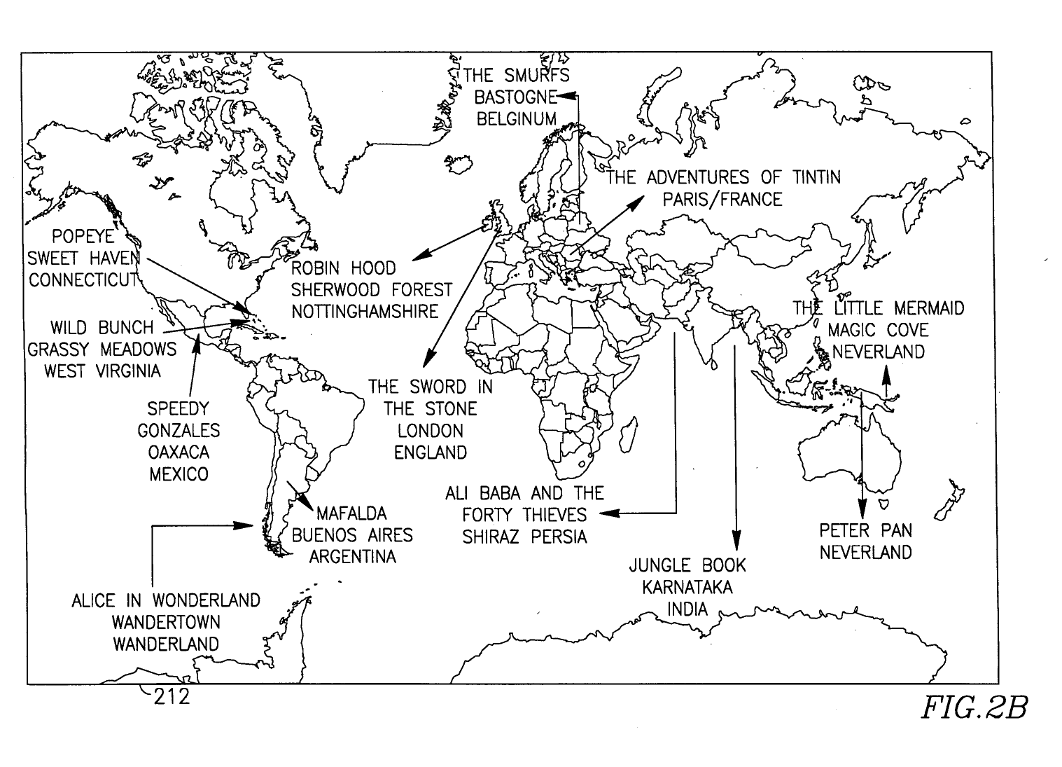

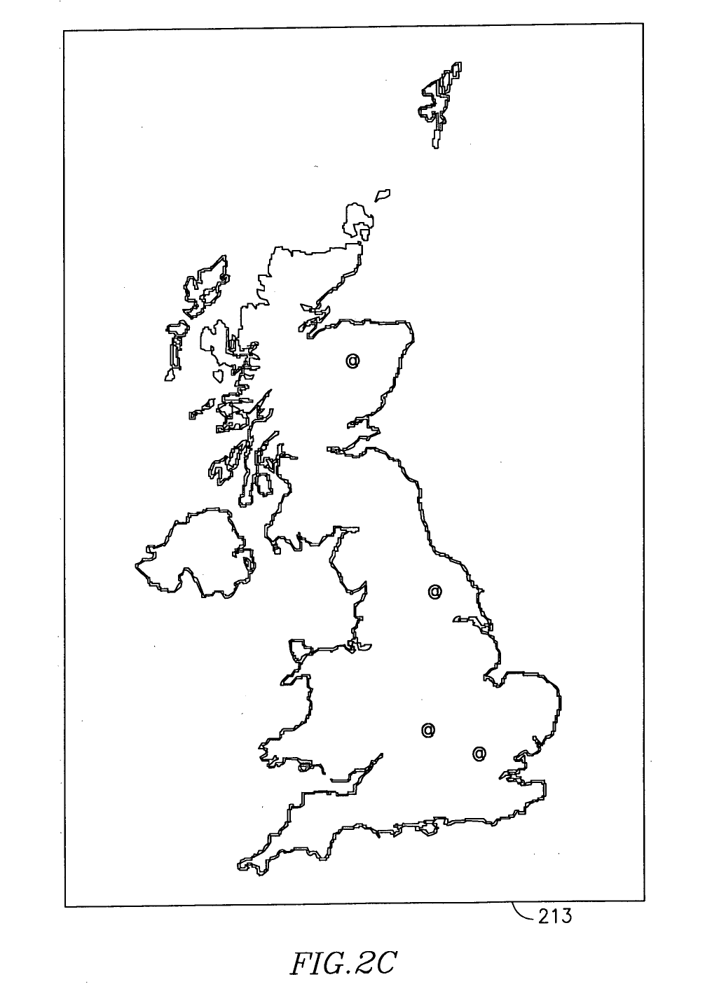

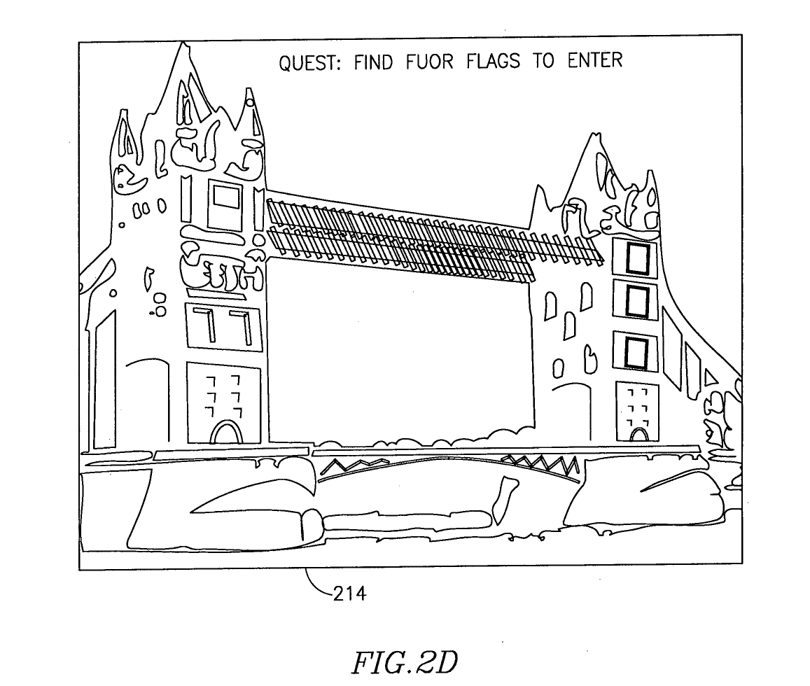

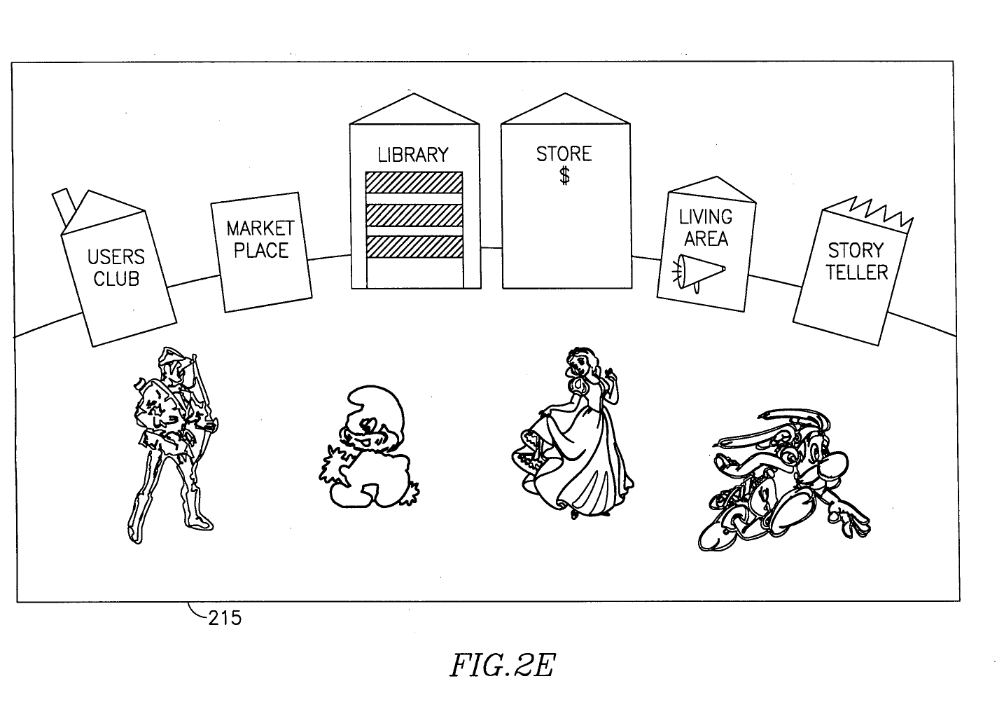

FIGS. 2A-2E schematically illustrate stages in the virtual game in accordance with some demonstrative embodiments of the invention. For demonstrative purposes, FIGS. 2A-2E are shown in the context of a globe similar to planet Earth; however, in some embodiments, various other types of landscapes may be used, for example, semi-realistic planet Earth, imaginary planet or landscape, a flat or non-globe landscape, multiple planets or areas, mythological worlds, fantasy worlds, historical worlds, ancient worlds, Science Fiction (Sci-Fi) worlds, the solar system, one or more planets of a system similar to the solar system, a solar-system planet or planets, or the like. The demonstrative discussion herein may be applied to such other types of landscapes or worlds.

As shown in FIG. 2A, a first stage includes a three-dimensional representation 211 of planet Earth. Each vortex represents a story-land virtual space. The user may rotate the globe using the mouse and/or keyboard or other suitable hardware components or input units (e.g., using rotate buttons 223 and 224), and may zoom-in and zoom-out (e.g., using zoom-in button 221 and zoom-out button 222). In some embodiments, optionally, the displayed globe continuously rotates at a relatively slow pace, thereby exposing the viewer to additional vortex locations as the globe rotates. Each vortex (or other type of pointer or icon) may represent a user-selectable story-land virtual space.

Alternatively, as shown in FIG. 2B, a two-dimensional representation 212 of planet Earth may be used. Each vortex (or other type of pointer or icon) may represent a user-selectable story-land virtual space. For demonstrative purposes, each vortex is shown as a circle; and names of such stories and their geographical locations are shown nearby.

In some embodiments, the first-stage representations 211 or 212 may include “secret” or “hidden” locations, for example, under water or in clouds, which may be accessible only to high-ranked users or to premium users. In some embodiments, the first-stage representations 211 or 212 may include graphical representations real-world geographic areas, as well as graphical representations of imaginary areas, e.g., “Atlantis”, “Wonderland”, or “Neverland”.

As shown in FIG. 2C, a second-stage includes a zoom-in representation 213 of a country or similar geographical region. FIG. 2C may be displayed in response to a user selection of a vortex in the first stage, or in response to a zoom-in by a user onto a selected geographical area. For example, the user clicks on (or otherwise selects, or zooms-in onto) England in the first stage, and in response an enlarged map of England is shown in the second state. Each vortex (or other type of pointer) may represent a story-land virtual space.

As shown in FIG. 2D, a third-stage representation 214 includes a graphical image corresponding to a particular location selected by the user in the second stage. For example, the user clicks on London in the second stage, and in response a graphical image of a London scene is shown in the third stage. A basic quest is played by the user in the setting of the third stage, as a condition or passageway to the next stage.

As shown in FIG. 2E, a fourth-stage graphical representation 215 of a story-land virtual space or “village” is shown to the user upon completion of the basic quest in the third stage. The village may be shown, for example, in third-person isometric view, in which the story takes place. Graphical representations of users may be shown, as well as graphical representations of Non-Playing Characters (NPCs) or “bots”. In some embodiments, graphical representations of characters from multiple stories or multiple virtual places (e.g., Robin Hood, Papa Smurf, Snow White, and Asterix) may be displayed in the same virtual village, and may virtually interact with each other in a single virtual location.

The village includes representations of multiple locations or components, for example, a users club in which worldwide users can meet, play games, share experiences, or the like. The users club may include multiple areas, for example, games (e.g., single-user and multi-user games granting the user with points or virtual money, each game having a hall of frame displaying the top-ranked users), cinema (e.g., displaying movie clips, movie trailers, story-land trailers), travel diary (in which users can share their travel experience), or the like.

The village further includes, for example, a market place (e.g., in which users may purchase, sell and/or trade virtual items and display their virtual goods); a movie room (e.g., displaying story-related movies); a village library (e.g., allowing the user to read books and comic tales); a virtual store (e.g., allowing the user to purchase virtual or real-world tale-related merchandize); a story teller (e.g., to convey the story to the user by audio/video); one or more story-specific locations where activities related to the plot take place; users living area, represented by a path leading to the users living area, and going through this path brings the user to his home; UGC area; and a representation of the entrance to the plot, in which the main quest begins.

In some embodiments, components may be positioned in common places across multiple villages, in order to create a familiar environment to the user and a common UI. In some embodiments, for example, the “village library” may be represented across multiple villages using a similar-looking component located at the bottom right side of the screen. In some embodiments, optionally, the graphic design of each village maybe branded or story-specific. In some embodiments, story-specific areas may be located outside the village.

For demonstrative purposes, some embodiments may include a story-land virtual space related to the fairy tale of “Little Red Riding Hood” (“LRRH”). The story-land virtual space may be implemented as a forest in Europe; the LRRH character lives in a village near the forest, and her grandmother lives at the other side of the forest. The story-land virtual space shows an animation of LRRH sent by her mother to bring food to her sick grandmother. In quest mode, the user receives his objectives, for example, to become a hero and help LRRH to safely deliver the food to her grandmother; or, to watch the story and participate in story-related online activities through the village interface.

In the quest mode, the tale of LRRH is told using animation, and is paused at the point where LRRH meets the wolf. A “collect the flowers” interactive game is invoked, in which the LRRH character (controlled by the user) has to collect flowers without stepping on mushrooms. Once a basket is filled with flowers, the interactive game terminates, and the tale animation resumes. Later, the tale animation pauses again when the LRRH character reaches a flooded path; a “jumping around” interactive game is invoked, in which the LRRH character (controlled by the user) has to jump from stone to stone in order to cross the flooded path. Upon successful completion, the interactive game terminates, and the tale animation resumes. Later, the LRRH character reaches the grandmother house, and the basket falls to the ground. A “protect the basket” interactive game is invoked, in which the LRRH character (controlled by the user) has to protect the basket from attacking forest animals. Upon successful completion, the interactive game terminates, and the tale animation resumes, showing the LRRH character entering the grandmother house and getting eaten by the wolf. As the animated tale is paused, a “hunt the wolf” interactive game is invoked, and this time the user controls a hunter character who has to throw pine cones at the wolf as the wolf pops his head between trees and bushes. Upon successful completion, the animated tale resumes, the user is congratulated and receives a virtual medal, and the user is teleported back to the village center. In some embodiments, an interactive game may include, or may utilize, UGC or UGC activities; optionally, an interactive game may include graphics or text generated by the user and/or by other users. In some embodiments, UGC may be utilized instead of, or in combination with, pre-programmed content.

In the virtual village, the user can meet characters from the story, for example, LRRH, the wolf, the hunger, the grandmother, and the mother. The user's character may interact with the other characters, who may automatically answer using pre-defined responses to user-selected pre-defined questions. The characters may be colorful and may perform gestures to attract the attention of the user. In some embodiments, the user may modify one or more features or visual features of the character (e.g., colors, background, size, accessories) using UGC activities.

The virtual village further includes a play room, for example, shown as a brick house having a straw roof, two large windows, and a wooden door. Inside the play room, colorful pictures hang on the walls, and the user may select through them one or more interactive games from the quest mode, as well as other tale-related games, single-player and/or multi-player games. The virtual village includes a market place, implemented as a collection of stands allowing users to display their virtual goods for trade. The virtual village additionally includes a village hall, shown as the largest shack in the village, allowing users to address the village council (e.g., the game administrator) with questions, suggestions, and comments; and further operating as a venue for social activities, for example, a multi-player dance event. The virtual village may include a village library, offering books, comics, and magazines for reading, renting or purchasing; a movie room, allowing users to watch the tale animation clip, as well as movie trailers and cartoons, or movies that other users created; a village virtual store, allowing users to purchase tale-related accessories (e.g., red cape, food basket, hunter's rifle) and gestures, in exchange to virtual money and/or real-world money; and other tale-related virtual locations (e.g., forest, LRRH home, grandmother house).

Some embodiments may utilize single-level or multi-level zoom-in/zoom-out interface in order to transport the user to the virtual village, to an interactive game, or to other virtual locations. In some embodiments, a zoom-in/zoom-out mechanism may transport the user between graphical representations having various sizes, for example: the universe; one or more galaxies; the solar system; planet Earth; continents; world regions (e.g., the Middle East, the Far East); countries; states (e.g., states within the United States); provinces or cantons; cities or towns; neighborhoods; streets; specific monuments or landmarks; or other suitable geographical areas or locations. In some embodiments, the zoom-in/zoom-out resolution includes only the world (e.g., planet Earth), user-selectable countries, which in turn expose the user to user-selectable cities; a user-selectable city activates a game associated with a work-of-authorship associated with the selected city. In other embodiments, the zoom-in/zoom-out resolution includes only Planet Earth with user-selectable countries, such that a user-selectable country activates a game associated with a work-of-authorship associated with the selected country. In some embodiments, selection of a first geographical area (e.g., Earth, a continent, or a country) leads the user to a second, smaller, geographical area; which in turn includes user-selectable locations (e.g., corresponding to cities) which invoke the corresponding games upon selection. In other embodiments, selection of a first geographical area (e.g., a country) may directly invoke the corresponding game, without necessarily zooming-in into smaller geographical areas (e.g., cities). In other embodiments, selection of a first landscape type (e.g. a jungle) leads to user to a smaller landscape type such as tree-tops or underground tunnels, further zooming in on smaller spaces such as a nest, a leaf, or the like. Other zoom-in/zoom-out resolutions may be used, and other number of levels may be used.

Some embodiments may include a hub allowing a user (e.g., a child operating a computer, a computing platform or a computing station) to conveniently and efficiently move among multiple virtual worlds or online worlds. For example, a virtual character, a virtual entity or a virtual character of the user, which may be constructed and used by the user within a first virtual world, may be transferred to a second, different, virtual world. Optionally, the transfer may include conversion or translation of features of the virtual entity, from features that are suitable for the first virtual world, to features that are suitable for the second virtual world. The user may thus be able to act and move within a Virtual Worlds Network (VWN), optionally implemented using hub-and-spoke architecture as described herein, allowing the user to create, play and interact with other characters (e.g., other users or NPCs and Bots), and allowing the user to easily move from a first virtual world of the VWN to a second, different, virtual world of the VWN while maintaining all or some of the user's achievements.

Some embodiments may allow children worldwide to efficiently and conveniently play, create and interact through online services and virtual worlds (e.g., Club Penguin, Webkinz, Neopets, or the like). Some embodiments, may allow advertisers and brand owners to efficiently reach young users online. Some embodiments may be tailored to suit a particular age group of users, for example, 6 to 12 year old users. Some embodiments may allow a child user, who utilizes a first virtual world for several weeks and months, and achieves various features or achievements but gets bored, to easily move into a second, different, virtual world, optionally retaining some or all of the features or advantages that the child's virtual entity achieved or accumulated in the first virtual world, instead of starting from scratch in the second virtual world. This may allow a child user (and optionally her parents) not be worried about the “switching cost” involved in switching platforms and moving from a first virtual world to a second virtual world, a switch which may conventionally result in a loss of avatar, online clothes, online accessories, online features, and online advantages that the child user purchased, as well as virtual currency that was purchased and/or earned. Some embodiments may further facilitate the process of exploring a variety of new virtual worlds, which is conventionally difficult due to a tedious registration process, the need to obtain parental approval, and payment requirements tied to entering each new virtual world.

Some embodiments may allow efficient and smooth consolidation of dozens of existing and/or newly-created virtual worlds. This may reduce challenges of user acquisition and user retention for virtual world operators. Some embodiments may allow independent survival of relatively small or relatively new virtual worlds, having low online traffic.

In some embodiments, a virtual hub allows a user to smoothly move from a first virtual world, which belongs to a first category of virtual worlds, to a second virtual world, which belongs to the first category and/or to a second category of virtual worlds. Categories or classes of virtual worlds may include one or more of the following demonstrative examples: books; television; movies; sports; content creation; education; fashion; lifestyle; socializing; chat; casual gaming; mirror worlds; role play; quests; fantasy; toys; real-world games; music; or the like.

Some embodiments may allow, for example, to provide improved online entertainment with more engaging and interactive experiences than conventional websites. Some embodiments may allow creation of new revenue streams without cannibalizing existing businesses. Some embodiments may allow new advertising opportunities, as well as a stronger relationship with brands and a longer product lifetime for virtual worlds, before and after marketing events. Some embodiments may be used in conjunction with fully-functioning virtual worlds, as well as with “miniature” or smaller virtual worlds, e.g., that may be part of a website of a video game company or a toy company.

Some embodiments may allow creation of a social media network for children, utilizing a single site registration and a single identity across a multiple array of hosted experiences. Additionally, as technology, build costs, and time-to-market for creating new virtual worlds remains a barrier-to-entry for new companies wishing to enter the space, some embodiments may optionally allow the use of a single semi-open platform which already includes many of the features necessary for a virtual world. In some embodiments, access to the multiple virtual worlds is granted via a single Universal ID associated with the user (e.g., a child user). Custom account management and social media tools may allow users to move freely through a variety of specialized content without losing their “avatar equity” or other virtual equity that they have purchased, earned, created, won, found, or otherwise obtained. Optionally, the virtual world hub may be implemented to accommodate content provided by external developers and/or license holders.

Some embodiments may include, for example, a unique hub and spoke design, using two-dimensional and/or three-dimensional graphics or visual objects, with the core social network experience (e.g., user profile, instant messaging, group chat areas, currency system and stores, status points, social spaces, UGC activities, or the like) housed in a browser-based (e.g., Flash-based) main area of the website; whereas specialized games, activities, story experiences and virtual worlds are available by traveling to the “spokes” of the virtual network.

In some embodiments, marketing revenue may be generated, for example, by hosting campaigns for feature films, television series or licensed properties. These may be added as “spokes” on the virtual network, since the existence of the fully-featured social network hub may allow all costs related to building the social network experience to be offloaded from a campaign's production budget. The virtual world network may further grow through developing an affiliate program for third-party developers. For example, Software Development Kits (SDKs) may be made available to external developers and license holders to create for this new “platform”. This may optionally include, for example, allowing existing virtual worlds or online game sites to synchronize or modify their registration paths and users with the unified network.

In some embodiments, since users maintain their virtual identity, keep their points and continue to build loyalty as they play across these emerging virtual properties, user retention is insured by the growth and continued adaption of the platform by external developers.

In some embodiments, a Virtual Worlds Network (VWN) may be implemented using a central web-site or using an online component accessible through a Web browser, without requiring the user to download and/or install a software component. In other embodiments, optionally, a software component may be downloaded and/or installed as part of the implementation of the VWN. In some embodiments, the VWN may be, for example, Flash-based and platform agnostic, able to be experienced on various hardware platforms, Web browsers, and/or Operating Systems (OSs). In some embodiments, the VWN may be developed and/or implemented using one or more engines and/or components by other developers or platform providers, or other suitable components, optionally utilizing a downloadable and/or installable Active-X component. Other suitable implementations or architectures may be used.

In some embodiments, the VWN may be implemented as a hub having a common or central theme. For example the hub may be an abandoned space station run by robotic space monkeys, with users able to “teleport” into unique experiences; the hub may be a mysterious subterranean world with strange tunnels (populated by strange creatures), that lead through a maze to different game experiences; the hub may be a secret government research lab that kids can “hack” into and play with; the hub may be an undersea world connected by translucent tunnels; or the like.

In some embodiments, the VWN may include a browser-based (e.g., Flash-based) “social network” functionality which may include, for example: Single Registration (register once for entire site); Persistent Avatar (persistence across all areas of site); Universal IM (ability to communicate with users anywhere on site, and optionally across the Web, e.g., using IM open APIs); Universal Currency (may be used in any VWN experience); Universal Wallet (e.g., the user has one wallet of points and currency of various virtual worlds, which he can access from within any VW on the VWN); Friends Finder (e.g., to find Friends wherever they are on the VWN, in the same VW or game that the user is in, or in other VW or other game); Friend Matcher (e.g., to meet new users who share your interests); Social Networking Tools (e.g., messaging, uploading content); UGC activities; Tamagochi-style virtual pet ownership (own a pet, train it, feed it, and compete it with others); and/or other suitable functionalities.

In some embodiments, thee VWN may include a virtual economy system including, for example: points and currency exchange (e.g., with ability to trade, buy or sell through an auction system, or other bidding system, points earned and currency obtained or earned in one VW for another VW's points or currency); a payment and billing system to allow users to pay for subscription, for virtual items or for virtual currency, using various payment methods (e.g., credit cards, debit cards, electronic check, wire transfer, mobile phone bill, telephone bill, PayPal accounts, retail card, pre-paid card, micro-transactions, nano-transactions, or the like). The user may have a Universal Wallet which is persistent across all virtual worlds in the VWN.

In some embodiments, the VWN may include locations such as, for example: My Room/My Profile, namely, a place to house the user's virtual goods, friend lists, messages, uploaded content, and “status” points for all to see; Leader Board/Game Lobby, namely, a place to meet garners, matchup for head to head game-play, or checkout the high scores; Theater, namely, a place for viewing trailers for upcoming films or for viewing licensed animation properties or audio/video content items; one or more User-Generated Content Galleries; one or more Social Chat Spaces allowing to meet other users, hang out and communicate; and other suitable locations.

In some embodiments, the VWN may be implemented using a hub-and-spoke model, in which a central virtual hub connects multiple spokes, each spoke providing a core content experience or an entertainment interest category which may be common to multiple virtual worlds. Optionally, each entertainment interest may become a content channel with multiple offerings in each area. In a demonstrative example, a VWN using the hub-and-spoke model may include five spokes of entertainment categories: an action/sports channel, a story experience channel, a creativity channel (e.g., allowing users to generate music, images, animations, and other content), a role playing channel, and a fashion/lifestyle channel. In some embodiments, a spokes may include original content, imported content, acquired content, re-skinned or reformatted content, branded content, or the like.

In some embodiments, as detailed herein, a user's virtual entity or avatar may adapt to each environment, and its features may be automatically modified upon switching from a first virtual world to a second virtual world. For example, a virtual entity having an avatar dressed as a Roman Gladiator in a Role-Playing Game (RPG) experience, will be modified and will utilize a different costume when the user of the virtual entity engages in an online snowboarding experience in the action/sports channel.

In some embodiments, a VWN may be developed and/or launched in stages. For example, a first version of a VWN may include: a browser-based (e.g., Flash-based) hub with social network functionality; a story-based experience based on a particular movie; one or more action gamelets; creativity tools for creation of user-generated content; a developed or an acquired RPG section; and a developed or an acquired fashion/lifestyle costume tool. In some embodiments, a staggered roll-out of content may be used; for example, a “soft” launch may allow core functionalities of the service to be tested by users prior to the formal release of the entire VWN. In some embodiments, before a VWN launches, individual gamelets may be released separately and syndicated to game sites and/or across the Web, to be used as advertisements for the VWN and to drive traffic back to its web-site.

In some embodiments, the VWN may then expand upon its initial content offering. Individual content experiences may become hubs as more content is added. As audience numbers rise, the VWN may host marketing campaigns for feature films, television shows, toys, and brands. These engagements may leverage various technologies which may be re-skinned for re-use. Expansion may further include acquisitions of virtual worlds and/or online games. Optionally, revenue may be generated by leveraging the game platform, for example, by white labeling game-based sites for videogame companies, and other brand or license holders. Furthermore, a beta release of the VWN affilitate program SDK may be launched, allowing external developers to place their web-sites on the VWN, which may by then evolve into a platform. This may further increase site traffic, optionally providing additional ad-related revenue. In some embodiments, blocks of animation programming may be presented in a Main Hub Theater, optionally including trailers for upcoming movie releases, thereby providing additional revenue for the VWN operator. In some embodiments, language-based or culture-based localization may be used or added; as well as on-site merchandising and sales of real world merchandise based on VWN properties.

In some embodiments, the VWN may be associated with multiple tiers of service. For example, a first tier includes free service, open to all users, optionally having a limited amount of activities or features, or optionally having bundled advertisements. A second tier includes a premium service, supported by monthly subscription, allowing the user to enjoy a greater selection of activities or features, or to enjoy content prior to its delayed-release into the free service, or to enjoy an advertisement-free experience.

In some embodiments, the hub-and-spoke model may continue to evolve. For example, spokes on the original hub may become hubs themselves, as the VWN continues to expand. A game hub emerges, as well as a RPG hub, a story hub, a creativity hub, or the like; these hubs become destinations by themselves, providing the VWN with multiple “front doors”. The main hub, in addition to its social network function, becomes a network directory with links to dozens of experiences. The affiliates program may proceed into wide release. Additionally, white-labeling of the VWN technology may be performed for clients desiring a four-walled social network experience. Optionally, an advertiser may “art direct” a registration path using its branding message. In some embodiments, original content offering on the VWN may be transferred to become a movie or a television series, as well as a full-featured video game.

In some embodiments, multiple VWNs may be developed, for example, directed at multiple age groups. For example, a first VWN may be directed at children aged 6 to 12, and a second VWN may be directed at teenagers aged 13 to 18. Optionally, a loyal user who outgrew the first VWN may smoothly transfer to the second VWN. Similar VWNs may be directed at students, adults, or the like.

In some embodiments, the VWN may include various types of properties, for example: original content; games and worlds developed from original content; acquired virtual worlds and acquired content; content based on licensing; or the like.

In some embodiments, VWN may be developed to attract users by utilizing multiple ways, for example: producing games to drive traffic to the VWN hub; syndicating the games (as well as associated videos and widgets) through other sites; sponsoring games at other game sites; leveraging existing traffic or acquired sites and licensed properties, using direct marketing, bloggers, public relations, and promotions; partnership with a payment card to generate retail promotion and micro-transaction and virtual goods sales; cross-promotion within virtual worlds of related activities; and other suitable advertising and marketing methods.

In some embodiments, the VWN operator may obtain revenue from various routes, for example: partnerships with media and entertainment companies; marketing, advertising and promotion spend from various advertisers; carriage fees for screening in the Main Hub Theater; creation of customized and/or branded game experiences; limited edition branded virtual goods; and content made for other channels on the site; white-labled sites for paying clients; website hosting fees, or virtual world hosting fees; licensing of virtual world games on digital and physical platform (e.g., retail, satellite, on demand, cellular, mobile); affiliate fees paid by sites joining the ever-expanding VWN, optionally utilizing the SDK; international distribution and localization; subscription fees for premium services offered to paying users; user micro-payments, nano-payments and virtual goods transactions for in-world items via a suitable card (e.g., “PayByCash”); or the like.

In some embodiments, the VWN may include Peer-to-Peer (P2P) components, or may utilize P2P architecture. In some P2P games, when only two players participate, a possible cheating by a user may be handled and/or avoided using a suitable mechanism. For example, once the P2P game ends, the loser may attempt to cheat and to manipulate his software so that his computer will send a false result; such that both the winner and the loser claim victory. One or more suitable mechanisms may be used to eliminate or cure cheating attempts. For example, a central game server may monitor the game substantially at all times; or other users' computers may monitor the game at all times (e.g., like a “jury”, which may or may not be aware of its role) and may send the outcome of the game to the game server. Other suitable mechanisms may be used.

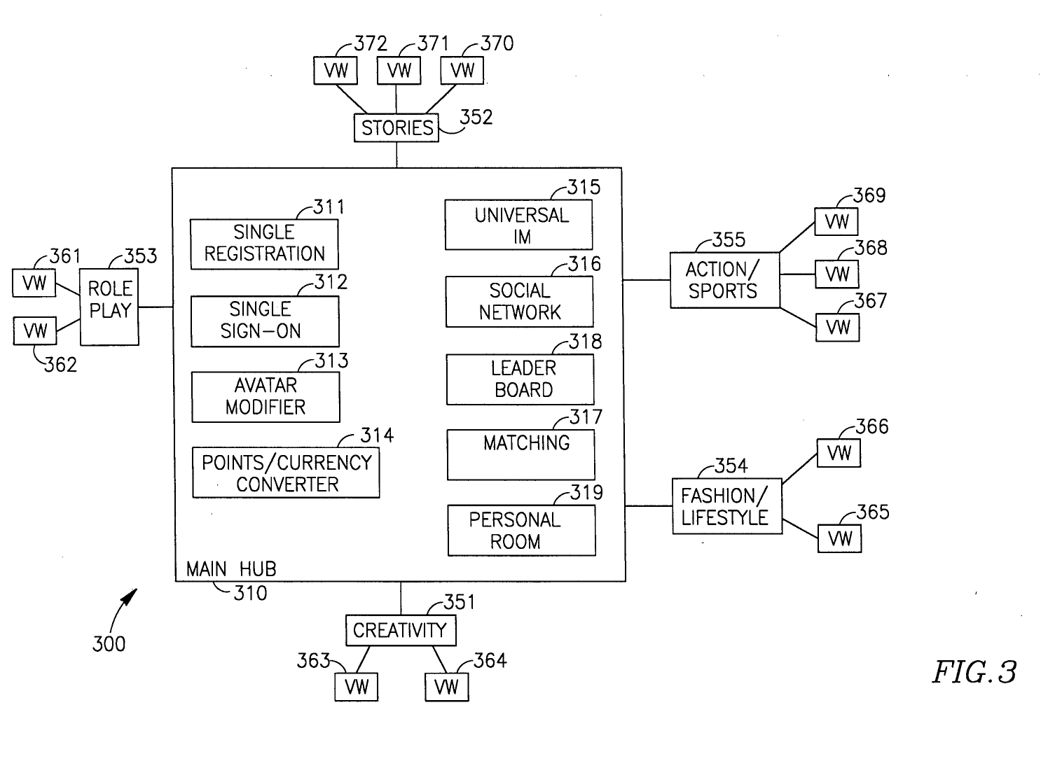

FIG. 3 is a schematic illustration of a Virtual Worlds Network (VWN) 300 in accordance with some demonstrative embodiments. The VWN 300 may be implemented using hub-and-spoke architecture. For example, the VWN 300 may include a main hub 310 and five demonstrative spokes 351-355. The hub 310 may include, or may be implemented using, for example, multiple features or modules 311-319. Other suitable components or features may be used. In some embodiments, the VWN 300 may be implemented, for example, using one or more servers, processors, memory units, storage units, input units, output units, communication units, databases, Operating Systems, software modules, and/or other suitable components.

A single registration module 311 may allow a new user to register once for multiple VWs. The user may select a single username and a single password, which he may later use for signing-on to the VWN 300, in order to gain access to multiple VWs. The single registration module 311 may receive from the user the desired username and password, and may optionally utilize multiple usernames and multiple passwords, associated with that user (e.g., through a client-side cookie, a server-side database, or other mechanism), for multiple VWs. For example, the user may select the username “JohnSmith” as a single registration username; and a server of the VWN 300 may actually define and store a username “JohnSmith12345” as a user-transparent username for a first VW, and a username “JohnSmith6789” as another user-transparent username for a second VW.

A single sign-on module 312 may allow an existing user to log-in once in order to gain access to multiple VWs. Optionally, the single sign-on may optionally use a lookup table or a database in order to convert the single sign-on details that the user inputs, into appropriate VW-specific sign-on details.

An avatar modifier module 313 may allow exchange, transformation and/or modification of avatars, avatar features, or other VW features associated with a virtual entity. In some embodiments, for example, the avatar modifier module 313 may utilize a lookup table or a conversion table, which converts a feature of a first VW (e.g., a sword in an action VW) into another feature of a second VW (e.g., a necklace in a fashion VW). In some embodiments, the conversion may allow the user to select between two or more transformation choices, upon switching from one VW to another. For example, the user may be presented with a choice, whether to convert his sword into a necklace or a bracelet. In some embodiments, the conversion may include automatic removal of the feature, for example, if no appropriate corresponding feature is available. For example, wings for virtual flying may be removed from the avatar when switching from an action VW into an undersea VW; and may optionally be automatically returned to the avatar upon returning to the action VW. Other suitable conversion methods may be used. In some embodiments, automatic modifications are performed not only with regard to the user's avatar, but also, optionally, with regard to other objects or items which may be associated with the user's virtual entity, for example, virtual accessories, virtual properties, characteristics of the virtual entity, or the like.

A points/currency converter 314 may allow exchange, transformation and/or modification of points, currency, or other valuables which were earned and/or purchased in first VW, into other values of points, currency or valuables of a second VW. The conversion may be performed using a lookup table, a database, an “exchange rate” (which may be constant or changing), or other suitable methods. For example, a user that had 50 virtual points in a first VW, may switch to another VW in which he will have, instead, 42 virtual points or 42 “stars” or other virtual objects or currency.

A universal IM module 315 may allow users to perform IM communications with other users across multiple VWs of the VWN 300. For example, a user of a first VW may utilize the universal IM module 315 in order to experience IM communications with another user which visits another VW. Optionally, one or more textual and/or graphical conversions or reformatting may be used to allow smooth communication across multiple VWs, to accommodate different presentation styles. In some embodiments, the universal IM module 315 may be able to connect, as a user-transparent proxy module, to the IM interface or to the IM servers of various VWs.

A social network module 316 may allow users to perform various social networking functions, for example, posting of pictures, tagging of pictures, forum communications, adding friends to a virtual social network, or the like.

A matching module 317 may suggest to a user to befriend other users which may interest him, based on past activities of the user, based on the user's areas of interest, or other parameters. The matching may be cross-VW, such that a first user who visits a first VW (e.g., related to fashion) may be offered to befriend another user who visits a second VW (e.g., also related to fashion, or not necessarily related to fashion but related to other interests or activities of the first user).

A leader board module 318 may present a cross-VW high-score table or top achievers. For example, a first user may be ranked first for having 940 points in a first VW, a second user may be ranked second for having 887 stars in a second VW, or the like.

A personal room module 319 (e.g., “My Room”) may allow a user to aggregate into a personal area of the VWN 300 multiple features or personal items that the user owns or collected. This may include, for example, personal images or photos, award or items own, accessories owned, points or currency earned, symbols of achievements or prizes, or the like.

The main hub 310 may lead the user to multiple spokes 351-355, for example, creativity spoke 351, stories spoke 352, role play spoke 353, fashion/lifestyle spoke 354, and action/sports spoke 355. Each spoke 351-355 may lead the user to multiple VWs associated therewith, for example, VWs 361-372. In some embodiments, UGC area(s) may be presented separately from other virtual destinations, or may be embedded as part of other virtual destinations, the main hub, spokes or channels, one or more VWs, or the like.

In some embodiments, the VWN 300 may be implemented using client/server architecture or using Web-based architecture. In some embodiments, for example, the VWN 300 may be hosted on a VWN server, into which the users may log-in; and the VWN server may then log-in or further interact with multiple servers of multiple, respective, VWs. This may allow, for example, the utilization of a single registration process or a single sign-on process for accessing multiple VWs hosted by multiple servers and/or multiple third parties. In some embodiments, for example, a VW may be presented as a frame or a pop-up or pop-under window, or as a layer within a present window. In other embodiments, a user-transparent frame may be used to maintain cross-VW information or details, whereas a user-visible frame may be used to present to the user the particular VW that the user engages in. Other suitable mechanisms may be used.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. It is, therefore, to be understood that the appended claims are intended to cover all such modifications and changes.

1-26. (canceled)

27. A system comprising:
a server to host a virtual hub associated with a plurality of spokes,
wherein each spoke leads users to a plurality of virtual worlds having a common characteristic,
wherein the virtual hub and the spokes comprise a virtual worlds network,
wherein the server comprises a single sign-on module able to receive from a user a first set of sign-on data items, and able to sign-on the user to a first virtual world and to a second virtual world.

28. The system of claim 27, wherein the server comprises an avatar modification module to transform a first avatar associated with the user in the first virtual world, into a second avatar associated with the user in the second virtual world.

29. The system of claim 28, wherein the avatar modification module is to transform the first avatar into the second avatar based on a server-side lookup table storing indications of corresponding avatars across a plurality of virtual worlds.

30. The system of claim 28, wherein the avatar modification module is to transform an accessory of the first avatar, associated with the first virtual world, into another accessory of the second avatar, associated with the second virtual world.

31. The system of claim 27, wherein the server comprises a currency converter module to transform a first balance in a first virtual currency associated with the user in the first virtual world, into a second balance in a second virtual currency associated with the user in the second virtual world.

32. The system of claim 27, wherein the server comprises an Instant Messaging (IM) communication module (a) to receive an IM message from a first user in the first virtual world, and (b) to present the IM message to a second user in the second virtual world.

33. The system of claim 27, wherein the server comprises a social networking module (a) to receive a social networking content item from a first user in the first virtual world, and (b) to present the social networking content item to a second user in the second virtual world.

34. The system of claim 27, wherein the server comprises a matching module to send to a user of the first virtual world a proposal to befriend a user of the second virtual world.

35. The system of claim 27, wherein the single sign-on module is to generate, from the first set of sign-on data items: (a) a first set of data items for signing-on the user to the first virtual world, and (b) a second set of data items for signing-on the user to the second virtual world.

36. The system of claim 27, wherein the server comprises at least one of:
a module for trading of virtual items among users of the virtual worlds network;
a module for auctioning of virtual items among users of the virtual worlds network;
a module for User Generated Content (UGC) activities.

37. A method of operating an interactive game, the method comprising:
displaying a graphical representation of a geographical area, wherein the graphical representation comprises one or more user-selectable icons corresponding to one or more respective geographical locations in said geographical area;
in response to a user selection of one of the icons, activating an interactive game having content related at least partially to the geographical location corresponding to the selected icon;
wherein the activating comprises: activating an interactive game having content related to a work-of-authorship, wherein the work-of-authorship is related at least partially to the geographical locatioS corresponding to the selected icon.

38. The method of claim 37, wherein the work-of-authorship comprises a work-of-authorship selected from the group consisting of:
a folk tale that takes place in the geographical location corresponding to the selected icon;
a fairy tale that takes place in the geographical location corresponding to the selected icon;
a fiction story that takes place in the geographical location corresponding to the selected icon;
a non-fiction story that takes place in the geographical location corresponding to the selected icon;
a television production that takes place in the geographical location corresponding to the selected icon;
a movie production that takes place in the geographical location corresponding to the selected icon;
an animated cartoon that takes place in the geographical location corresponding to the selected icon; and
a story written by an author from the geographical location corresponding to the selected icon.

39. The method of claim 37, comprising:
playing a digital version of at least a portion of the work-of-authorship;
pausing the playing of the digital version;
activating an online game related to the work-of-authorship; and
upon successful completion of the online game, resuming the playing of the digital version.

40. The method of claim 37, comprising:
generating an online chat session between (a) a first user represented by a first character of said work-of-authorship, and (b) a second user represented by a second character of said work-of-authorship.

41. The method of claim 40, comprising:
receiving from the first user a selection of a chat phrase from a pre-defined list of chat phrases;
displaying the chat phrase to the second user;
receiving from the first user a selection of a chat phrase in a first language; and
displaying to the second user a translation of the chat phrase in a second language.

42. The method of claim 37, comprising:
generating an online chat session between a user represented by a first character of said work-of-authorship and a computer-controlled second character of said work-of-authorship.

43. The method of claim 37, comprising:
generating an online chat session between a first user represented by a character of said work-of-authorship and a second user represented by another character of another work-of authorship.

44. The method of claim 37, comprising:
displaying a graphical representation of a virtual village corresponding to a site mentioned in the work-of-authorship;
displaying in the graphical representation of the virtual village a graphical representation of a character from said work-of-authorship; and
animating the graphical representation of the character in response to a user input.

45. The method of claim 37, wherein the geographical area comprises one or more of:
a two-dimensional landscape, a three-dimensional landscape, planet Earth, a real-life planet, a solar system, a portion of a solar system, an imaginary planet, a fantasy world, a historical world, an ancient world, a mythological world, a fiction world, and a semi-realistic world;
wherein at least part of the interactive game comprises User Generated Content (UGC).
